(19) United States
(12) Patent Application Publication
(10) Pub. No.: US 2008/0215383 A1
(43) Pub. Date: Sep. 4, 2008

(54) AUTOMATED AIRLINE SYSTEM AND METHOD

(75) Inventors: John H. Sundt, Tucson, AZ (US); Robb Good, Carlsbad, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: Outsmarttheherd.com, LLC

(21) Appl. No.: 11/840,195

(22) Filed: Aug. 16, 2007

Related U.S. Application Data
(60) Provisional application No. 60/838,458, filed on Aug. 16, 2006.

(51) Int. Cl. G06Q 10/00

(52) U.S. Cl. 705/5

(57) ABSTRACT

A computer based system and method for automated travel related boarding document booking, retrieval, account creation and purchase account credit system which provides for customer receipt of boarding documents via electronic transmission, including notification of same and of allied services. A method for customers with reservations is included to enable early check in and/or have their boarding documents transmitted to them as well as receive updated information regarding transportation status, local terminal conditions and amenities. The system incorporates methodology relating to the customer's establishment of an automated account, the creation of the automated account, payment of a fee for securing the preferred boarding documents, retrieval of a boarding document and the earning of account purchase credits. Allied automated services include providing the registered passenger with updated transportation information, transit terminal amenities, and electronic commerce links for private commercial transactions.

### CROSS-REFERENCE TO RELATED APPLICATIONS

This application claims priority to and benefit of U.S. Provisional Application No. 60/838,458, entitled “Automated Airline System and Method” and filed on Aug. 16, 2006.

### FIELD OF INVENTION

The present invention relates, generally, to a computer based automated airline system and method, and more particularly to a system and method for boarding pass booking, retrieval, account creation, purchase account crediting, and messaging that provides for passenger receipt of boarding passes and related messages via electronic transmission, including notification of same and of affiliated services.

### BACKGROUND OF THE INVENTION

Airlines have traditionally sought to balance cost efficient methods for boarding and departing passengers with considerations for customer satisfaction and fast flight turnaround. One cost efficient carrier has sought to maximize its efficiency by allowing passengers to board by class. While this methodology has apparently enhanced flight speed turnaround it may have resulted in some negative experiences for customers. Until recently, this carrier did not allow passengers to retrieve their boarding passes electronically until 12:01 a.m. of the day of the flight. This same carrier has recently allowed passengers to procure their boarding passes directly from the carrier up to twenty four (24) hours prior to flight departure.

While enhancing efficiencies, these operational rules have continued to have some negative impact on the business traveler. Many travelers are flying in a series of connecting business flights, and on some airlines this may prevent the traveler from timely securing a boarding pass that enables their placement earlier in the boarding order.

In addition, individuals who ultimately travel in a group after making their desired connections, often depart from different locations and have difficulty securing boarding passes allowing them to secure earlier boarding and stay together in a group. As a matter of convenience, non-business travelers also seeking to travel together have a preference for early boarding and traveling together as a group.

### BRIEF DESCRIPTION OF THE DRAWINGS

A more complete understanding of the present invention may be derived by referring to the detailed description and claims when considered in connection with the drawing Figures and where the Figures illustrate various aspects of the present invention in accordance with various embodiments of the present invention.

FIG. 1 illustrates a block diagram of an embodiment of a method for booking the boarding documents;

FIG. 2 illustrates a block diagram of an embodiment of a method for payment processing associated with the reserving the boarding documents;

FIG. 3 illustrates a block diagram of an embodiment for establishing the client's account associated with the reservation of the boarding documents;

FIG. 4 illustrates a block diagram of an embodiment for automatically retrieving the customer's boarding documents; and

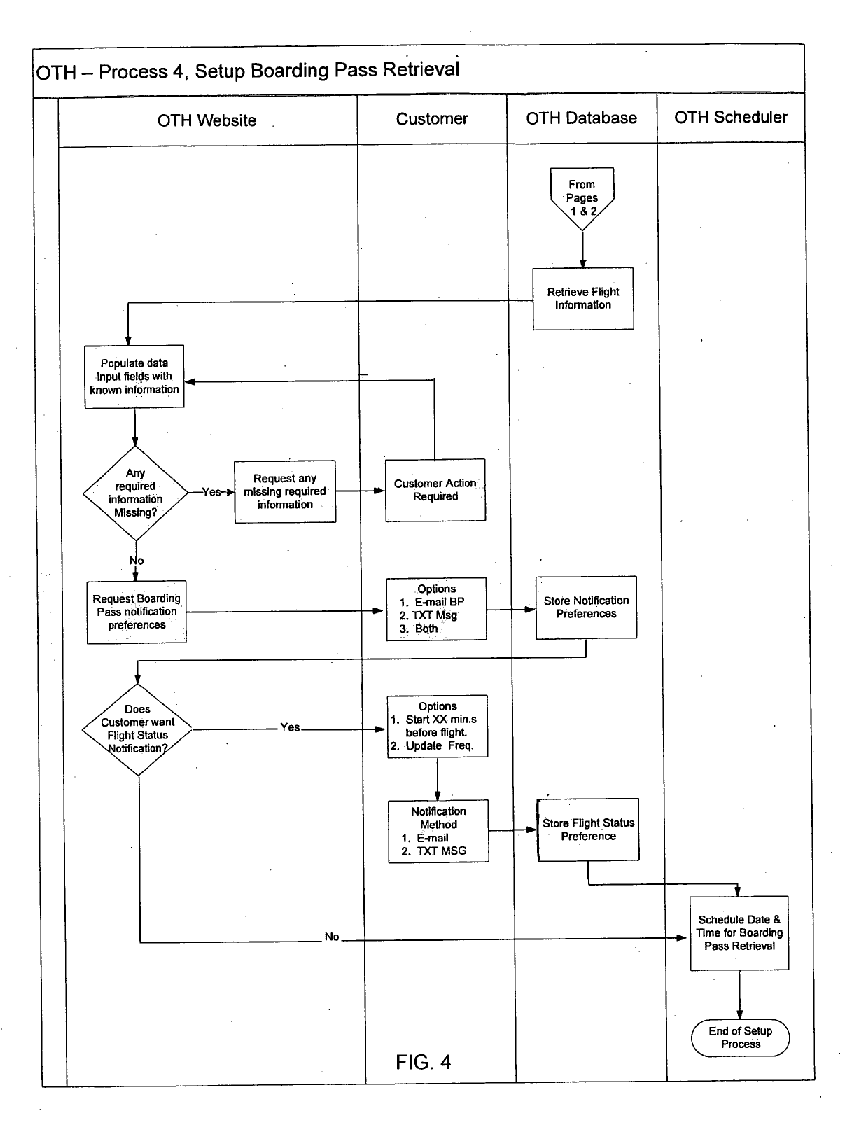

FIG. 5 illustrates a block diagram of an embodiment for a method for the customer's purchase of account credits associated with the reservation of the boarding documents.

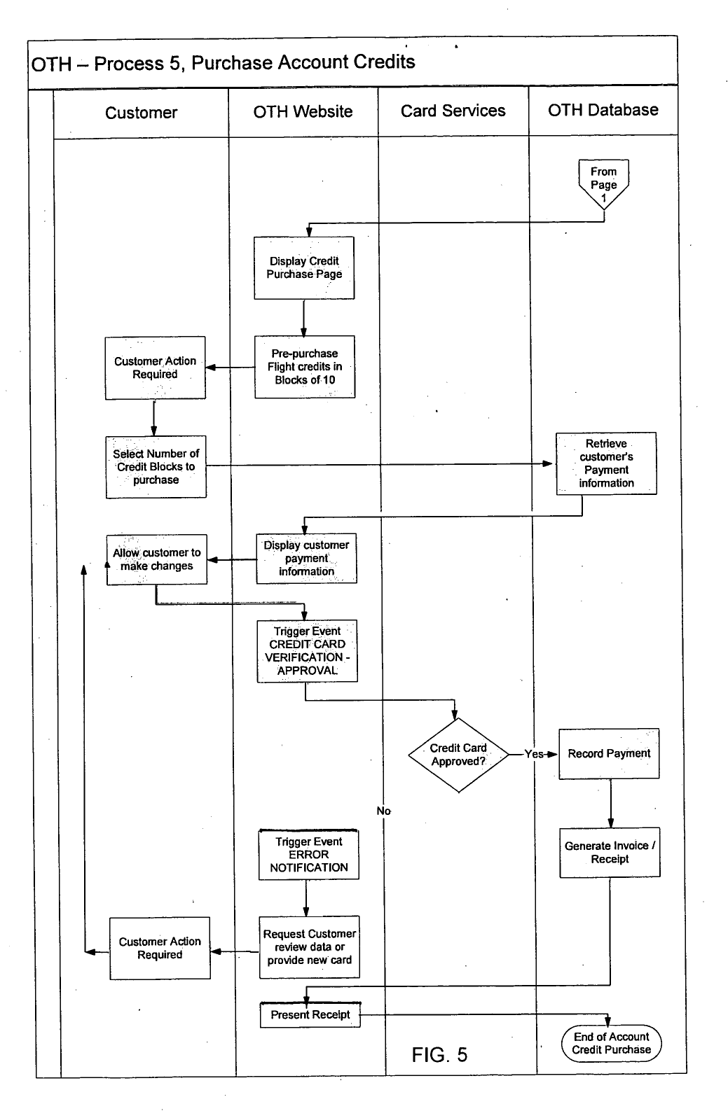

### DETAILED DESCRIPTION

The detailed description of exemplary embodiments of the invention herein makes reference to the accompanying drawings, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional features of airline reservation systems and other functional aspects of the present invention may not be described in detail herein. It should be noted that many alternative or additional functional relationships or physical connections may be present in a practical system;

The customer satisfaction challenges posed by the above described process are solved and a technical advance is achieved by an automated computer based boarding pass booking, retrieval, account creation and purchase account credit system which provides for passenger receipt of boarding passes via electronic transmission, including notification of same and allied services.

In accordance with one embodiment of the present invention, an aspect of the system provides for processing and transmitting boarding passes for a passenger without the constraint of the twenty four (24) hour rule. Using the system, passengers in different locales may register their account and information on line well before departure and receive via electronic confirmation the boarding pass itself, or an automatic check in allowing them to procure their pass at a kiosk or other ticketing station. This information may be received at home, or for those with text enabled mobile devices, received while in transit. This enables, by way of example and not limitation, business passengers engaged in multiple flights to procure their place in the earlier boarding group. It also facilitates their ultimately traveling together by allowing individuals traveling from multiple locations and/or according to different originating or connecting schedules to procure boarding passes within the earlier boarding group.

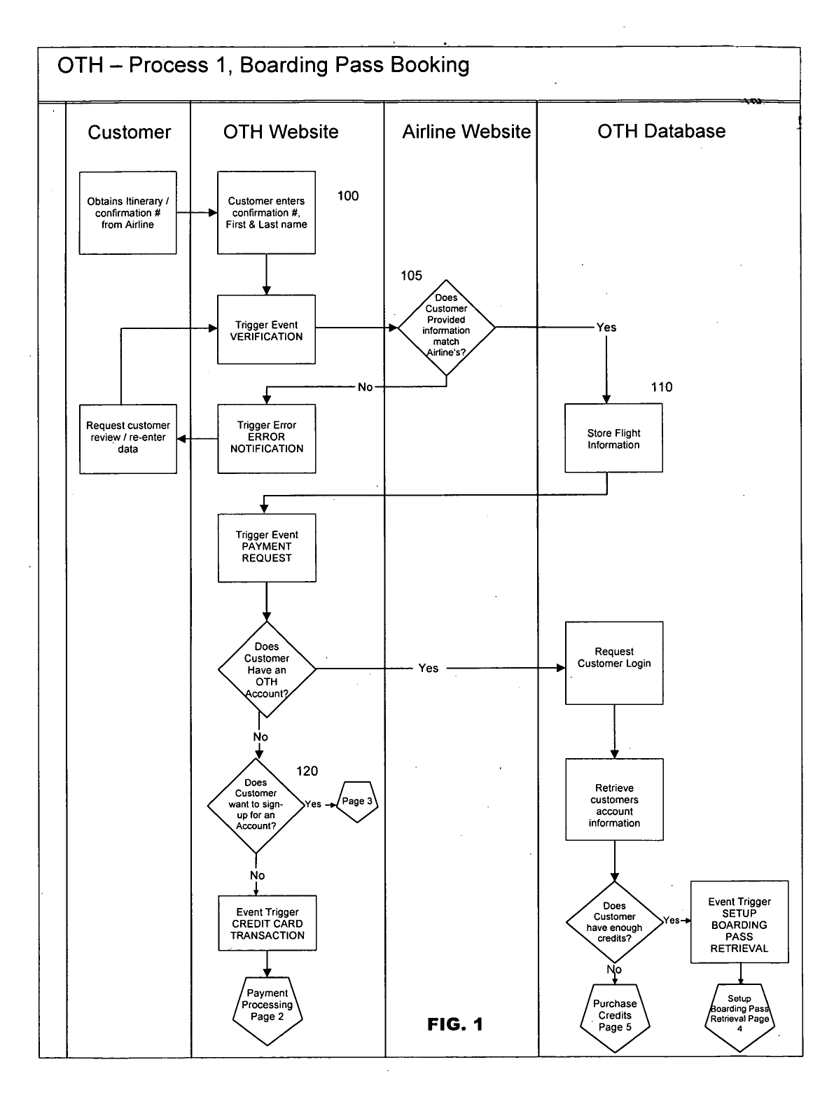

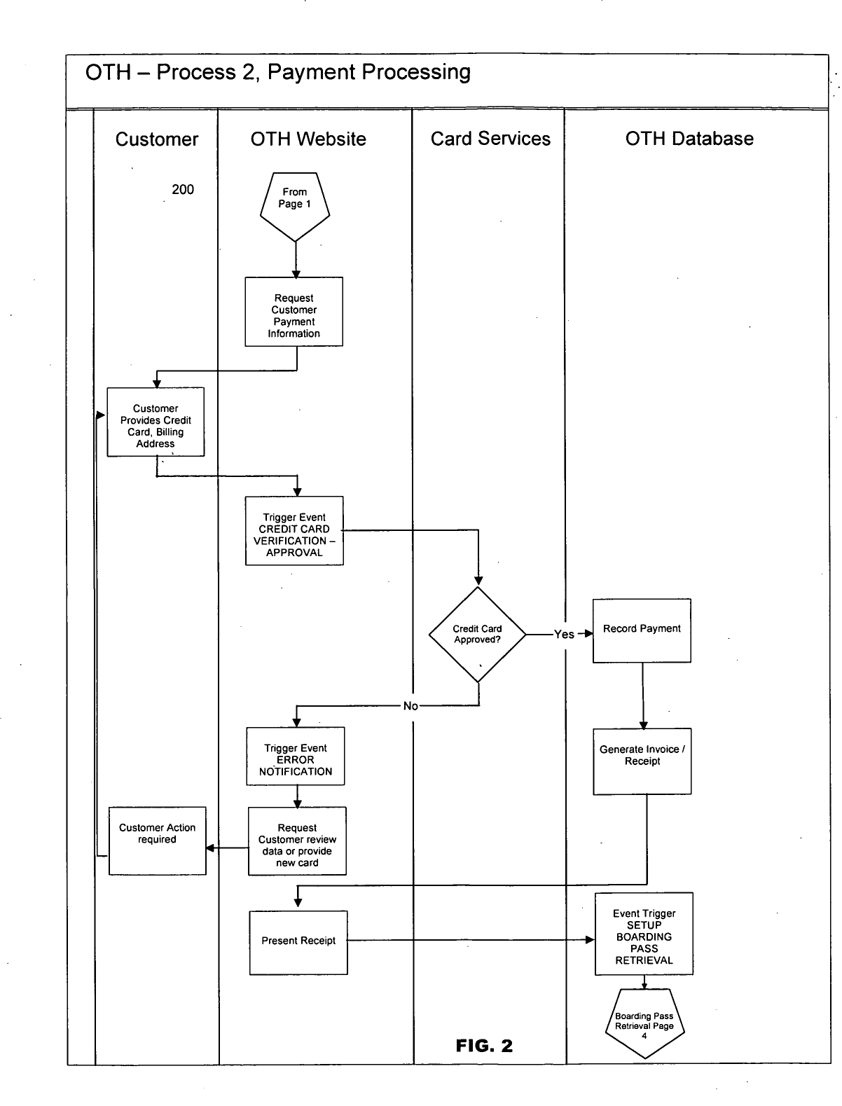

With reference to FIG. 1, a customer may access the system of the present invention by using a conventional browser to access a website that is affiliated with the system. For example, the customer can access the web-site from a home computer by using any conventional Internet browser such as Microsoft Internet Explorer, Netscape Navigator, and/or the like. The browser can be used to display the various web-pages of the web-site on the home computer. The customer utilizes the web-site to enter information such as a confirmation number for a particular flight along with other identifying information (step 100). The web-site will utilize the confirmation number and confirm that it matches the airline information (105). If so, the flight information will be stored in a database associated with the system of the present invention (110). With continuing reference to FIG. 1 and to FIG. 2, the customer may be prompted to establish an account (120) with the automated airline system and to provide payment information (200) for the account.

In accordance with another aspect of the present invention, the automated computer based boarding pass system, provides for the traveling passenger to receive through a text enabled mobile device, updated flight departure information as well as local airport conditions.

In accordance with another aspect of the present invention, the passenger may receive, via electronic communication, information regarding airport amenities and commercial operations located close to their scheduled arrival or departure gates, such as (by way of example and limitation) news or gift shops, restaurants, coffee shops or other. This part of the comprised system allows not only for enhanced traveler satisfaction but the opportunity for local commercial operations to heighten their visibility and enhance revenues. For airport operators it facilitates passenger location of amenities ranging from restrooms to transit trams and shuttle buses moving from gate to gate, thus enhancing the traveling experience.

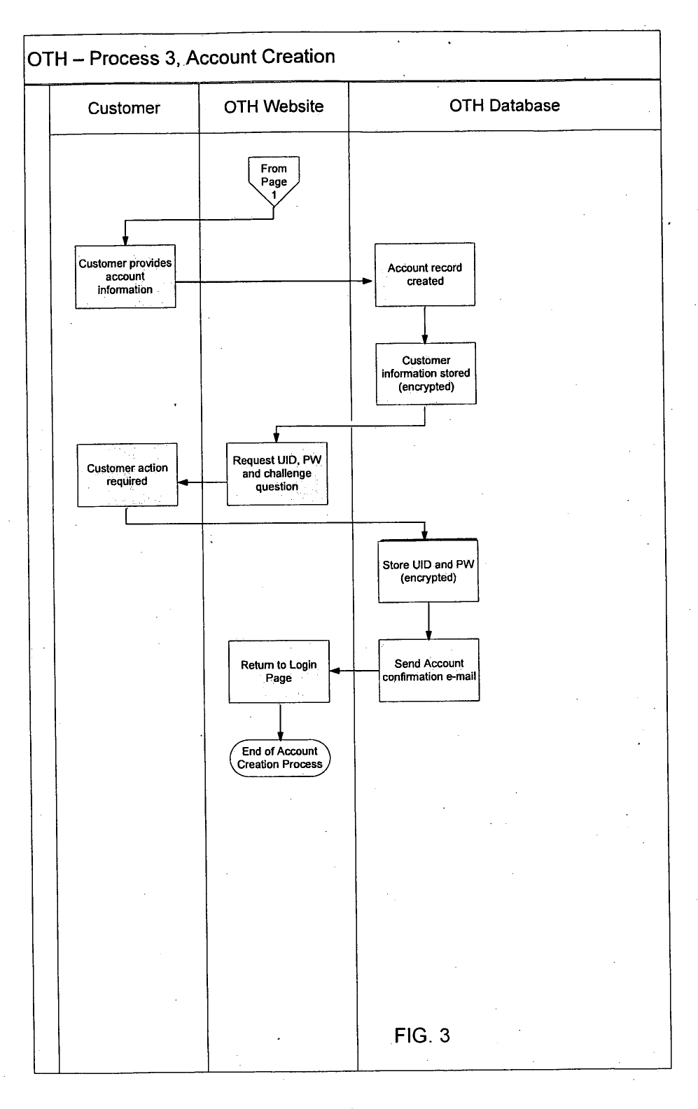

With reference to FIG. 3, the customer/passenger may establish a member profile that can include items that are of interest to the passenger. For example, the passenger may be interested in knowing where coffee vendors (e.g., Starbucks) are located in the airport or where newspaper stands are located in the airport. The customer will then have the option to receive text messages or similar messages that contain information about items of interest, such as the location of Starbucks or newspaper stands that are near the passenger's departure gate at the airport.

In accordance with another aspect of the present invention, passengers may also register for electronic commerce links and sites which may, among other things, permit their sale or purchase of such items as drink tickets and ticket vouchers or procurement of other services.

In accordance with another aspect of the present invention, travelers may establish purchase credit accounts which enable their deposit of funds to handle multiple flights, as well as earning credits toward the grant of free early boarding pass delivery and notification.

The various services provided by the system and methods of the present invention have been designed as completely automated processes that are offered through web and text messaging systems. Customers must establish an account and set up a membership profile if they wish to utilize extended services beyond obtaining a boarding pass.

The services available via the web-site include, but are not limited to:
Obtaining boarding passes
Paying for boarding pass retrieval service
Establishing an account
Ability to establish a member profile that can include items of interest within airport terminals. Items of interest can be linked to advertisements that are delivered as printed coupons appearing at the bottom of boarding passes and informational text messages that are sent to the customer when requested.
Support for a concierge service where customers can utilize third party hotel partners to deliver boarding passes to their rooms or provide them at time of checkout.

In accordance with an aspect of the present invention, if a customer has signed up for the concierge service, then boarding passes will be delivered to the customer's hotel room, provided to the customer at the time of checkout, or otherwise delivered to the customer prior to or at their arrival at the airport.

The system and methods of the present invention provide for various services that may be delivered via text messages or similar technologies. Based on customer profiles established on the web-site, a computer server that is associated with the system will send a text message to the customer alerting them one or more of the following:
Flight status
Gate and terminal for where the customer's flight is boarding
Information about services of interest to this customer that are available at the airport

In addition, the customer has the option to reply to the text messages and receive additional services. In accordance with one embodiment of the present invention, the customer will respond to a received text message with a single number response that indicates one of the following conditions:
1—Accept
2—Decline
3—Cancel all future alerts for this flight
4—Request next day flight info
5—Request Additional Services
6—Request Earlier Flight
7—Request Later Flight
8—Reserved for future purchase options
9—Unassigned/Future features

In accordance with one embodiment of the present invention, a customer response to a text message may operate in the following manner. A first text message may be sent to the customer that includes the following information:
Your SW Flight #XXXX is on-time, boarding from Terminal #X, Gate #XX.
To continue receiving flight status updates, do nothing.
To cancel future updates, reply with the #3.
For information on your preferred services, reply with the #5.
To check availability on an earlier flight, reply with the #6.
To check availability on a later flight, reply with the #7.

The user may respond to the text message with the appropriate selection. If the user replies with #7 and requests information on a later flight, then the system may operate in the following manner. The system matches the phone number of the user to a customer account information and retrieves the current reservation/trip information including the airline. The system will then query the airline's reservation system to identify availability of later flights for that day and reply back with one of two messages.
Optional reply 1: The next available flight is scheduled to depart at XX:XX AM/PM on DATE and arrives at your destination at XX:XX AM/PM. This light requires a fare upgrade of $XXX.XX.
To transfer your ticket and boarding pass to this flight and pay any additional airline charges, reply to this message with the #1.
To Decline this flight option and check for an earlier flight reply with the #6.
To keep current reservation, do nothing.

Optional reply 2: No later flights are available today.
If you wish to check tomorrow's flights, reply to this message with the #4.
To check for an earlier flight reply with the #6.
To keep current reservation, do nothing.

It should be appreciated that a similar process could be used if the customer requests an earlier flight.

In accordance with an embodiment of the present invention, if the customer responds with #5 as a request for additional services, then the system would operate in the following manner. The system will capture the reply message and match the phone number of the message sender to a customer account. Once the customer has been identified, the system will query the customer's profile to determine if the customer has any selected services or vendors identified. For example, if this customer has selected Starbucks as a preferred vendor, then the following may occur:
Reply message to customer: Starbucks is located in your Terminal by Gate #XX and Gate #XX and in the Food Court located at XXXXXXXXXXX.

If the customer has selected additional services, the system will reply with similar statements for those services. Other examples of additional services include newsstands, restrooms, snack bars, alcohol serving bars, and the like. An advertising fee may be charged to various vendors for delivering these messages. In addition, promo codes could be included in the message.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” Further, no element described herein is required for the practice of the invention unless expressly described as “essential” or “critical.”

We claim:

1. A method for obtaining a boarding pass for a flight, the method comprising:
creating a personal profile;
providing flight information;
receiving, via an electronic message, the boarding pass for the flight.
